(19) United States
(12) Patent Application Publication
(10) Pub. No.: US 2009/0079279 A1
(43) Pub. Date: Mar. 26, 2009

(54) Water Cooled Stator for a Direct Drive Torque Motor

(76) Inventors: Fu-Yuan CHENG, Taichung Industrial Park (TW); Chih-Hsien Chao, Taichung Industrial Park (TW)

Correspondence Address: Dr. BANGER SHIA, 102 Lindencrest Ct., Sugar Land, TX, 77479-5201, US

(21) Appl. No.: 11/859,740

(22) Filed: Sep. 21, 2007

(51) Int. Cl. H02K 9/19

(52) U.S. Cl. 310/54

(57) ABSTRACT

A water cooled stator for a direct drive torque motor comprises a stator base, silicon steel sheets, coils, sealing glue and a water cooled sealing tube. A helical water groove is defined in the outer surface of the stator base. The silicon steel sheets and coils are fixed in the stator base by the sealing glue after solidification. Then, the water cooled sealing tube is directly mounted outside the stator to seal the helical water groove by liquid. By such arrangement, the water cooled sealing tube is used to accomplish simple and independent water cooled sealing, the volume of the products can be effectively reduced, and the water cooled sealing tube can be applied to various tool machines.

### BACKGROUND OF THE INVENTION

1. Field of the Invention

The present invention relates to a motor stator, and more particularly to a water cooled stator for a direct drive torque motor which utilizes a water cooled sealing tube to accomplish simple and independent water cooled sealing, the volume of the products can be effectively reduced, and it can be applied to various tool machines.

2. Description of the Prior Art

The motors are used more and more widely in modern industries, and are generally categorized into external rotor, internal rotor and so on. In addition to the high precision in the feeding transmission, the motor also has the advantages of low friction loss, high energy conversion efficiency and low noise, etc. Therefore, the motors are obviously important to the modern industrial tool machines.

The existing direct drive torque motors are applied to the drive of the axis equipments of high precision, such as the automatic equipment, the indexing plate and various tool machines. However, in order to improve the torsional performance and lower the temperature of coils in operation, the existing direct drive torque motor products are all provided with cooling equipment.

Referring to FIG. 1 and 2, the conventional direct drive torque motor utilizes coils 101 of an outer stator 10 to closely cooperate with the magnet 111 of the inner rotor 11. A shaft 12 is fixed in the center of the inner rotor 11. The outer stator 10 includes a box-shaped aluminum base 102, an annular stator 103, silicon steel sheets 104 and coils 101 that are arranged sequentially from the outer to the inner periphery of the outer stator 10 A helical water groove 1031 is formed around the annular stator 103, and a cooling water circulating hole 1021 connected to the helical water groove 1031 is defined in the a box-shaped aluminum base 102, and cooling water is injected to cool interior part for the helical water groove 1031. Though the abovementioned design has been brought into use, it still has the following disadvantages:

Firstly, the box-shaped aluminum base 102 of the conventional direct drive torque motor has a large volume and consumes a lot of material, it must be mounted on a machine, and it is not adapted for modular application since its heavy body can not be easily detached. Therefore, the market is awaiting a new design which can be easily and independently used in various products.

Secondly, the production of the box-shaped aluminum base 102 of the conventional direct drive torque motor is complex. The box-shaped aluminum base 102 is provided with a receiving recess 1022, an axle hole 1023, threaded holes 1024 and a cooling water circulating hole 1021. Further, fixed structure must be designed to cooperate with different machines. Therefore, the conventional box-shaped aluminum base 102 has a high cost of production.

The present invention has arisen to mitigate and/or obviate the afore-described disadvantages.

### SUMMARY OF THE INVENTION

The primary objective of the present invention is to provide a water cooled stator for a direct drive torque motor, so as to enlarge the application scope and reduce the volume of the products.

To achieve the abovementioned object, the main components of the present invention comprises a stator base, silicon steel sheets, coils, sealing glue and a water cooled sealing tube. A helical water groove is defined in the outer surface of the stator base. The silicon steel sheets and coils are fixed in the stator base by the sealing glue after solidification. Then, the water cooled sealing tube is directly mounted outside the stator base to seal the helical water groove. By such arrangement, the water cooled sealing tube is used to accomplish simple and independent water cooled sealing. Since the water cooled sealing tube is without any protruding structures, so the volume of the products can be effectively reduced. Additionally, the tube shaped design of the water cooled sealing tube can be applied to various tool machines, and the water cooled sealing tube can be disposed at different positions in various tool machines.

The thickness of the abovementioned water cooled sealing tube needs to meet the demand of liquid sealing and protecting the inner components. Moreover, the thickness of the water cooled tube can be adjusted in accordance with the tube-making thickness in general industrial. The present invention does not limit the thickness.

The secondary objective of the present invention is to provide a water cooled sealing stator for a direct drive torque motor, so as to reduce the cost.

In order to achieve the abovementioned object, the water cooled stator for a direct drive torque motor in accordance with the present invention utilizes the water cooled sealing tube to directly mount outside the stator base to seal the helical water groove by liquid. By the arrangement, the water cooled sealing tube can be mass produced rapidly by utilizing the tube-making technology. The water cooled sealing tube consumes less material, and the tube-making technology is simple and has a low cost. Therefore, the present invention can reduce the cost.

When the water cooled sealing tube cooperates with an annular water cover board to seal the stator, whereby the water cooled sealing tube and the stator base are fixed to each other by screws. So it is simple to assemble and position the water cooled sealing tube and the stator base.

### BRIEF DESCRIPTION OF THE DRAWINGS

FIG. 1 is an exploded view of a conventional direct drive torque motor;

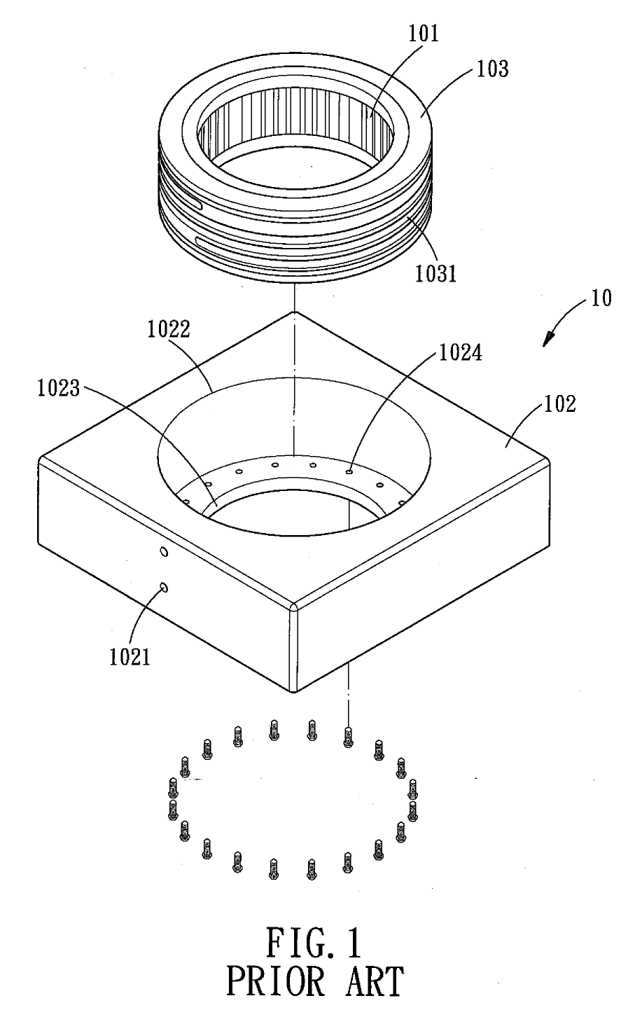

FIG. 2 is a sectional view of the conventional direct drive torque motor;

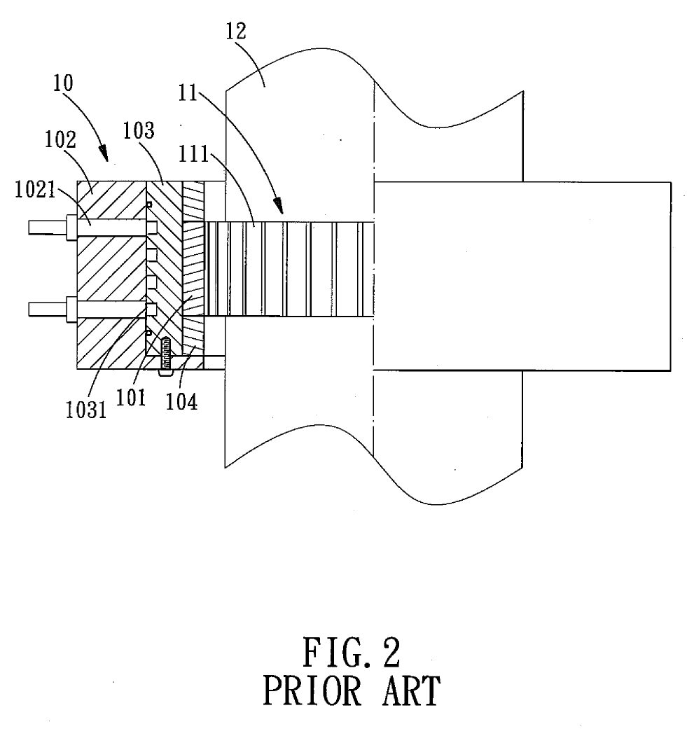

FIG. 3 is a perspective view in accordance with the embodiment of the present invention;

FIG. 4 is an exploded view in accordance with the embodiment of the present invention; and

FIG. 5 is a sectional view in accordance with the embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

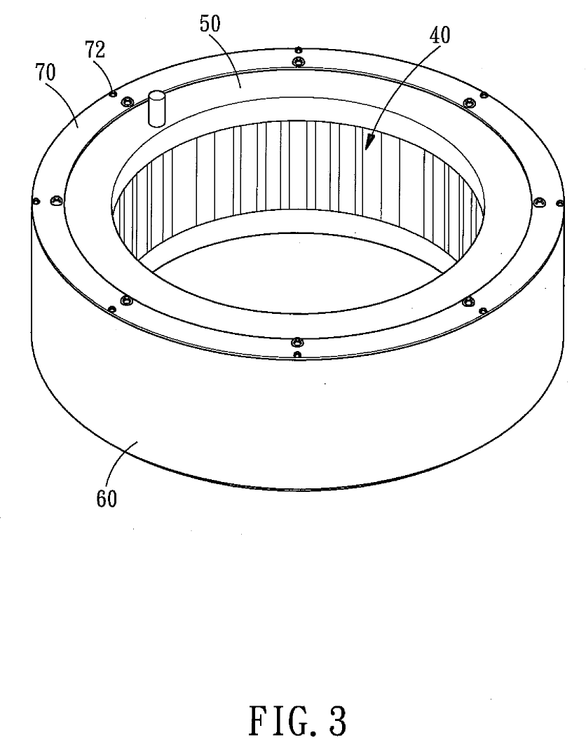

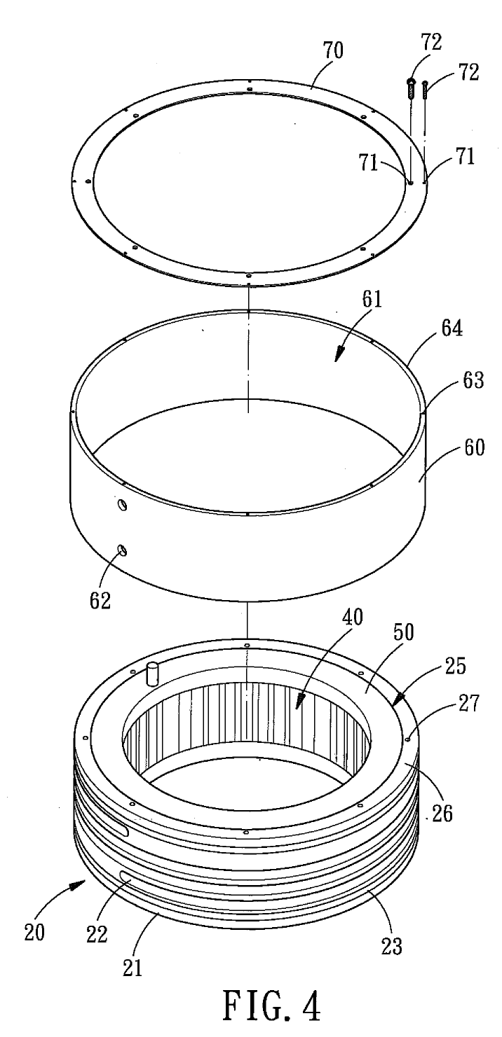

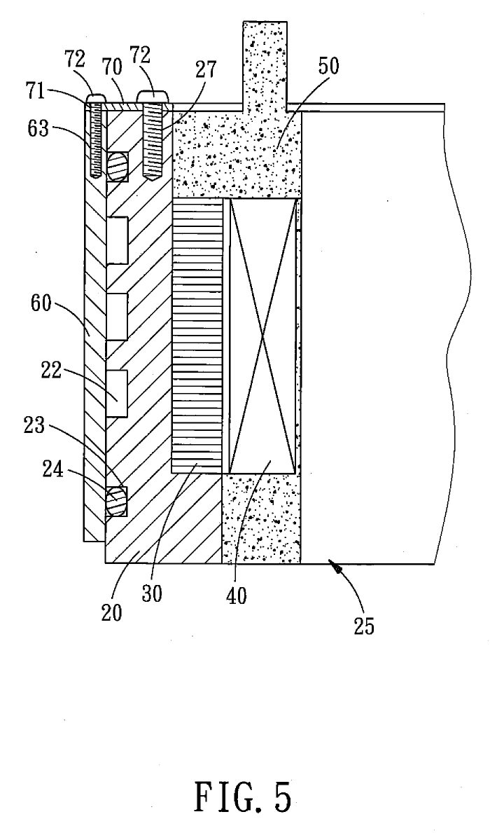

Referring to FIGS. 3-5, a water cooled stator for a direct drive torque motor in accordance with the preferred embodiment of the present invention is shown and comprises: a stator base 20, a plurality of steel sheets 30, a plurality of coils 40, sealing glue 50, a water cooled sealing tube 60 and a water cooled cover board 70. Further, the water cooled stator cooperates with the rotor shaft (not shown) of the direct drive torque motor.

The stator base 20 is annular shaped. A helical water groove 22 is defined in the outer surface 21 of the stator base 20. An 0-shaped ring 24 is mounted in a liquid sealing groove 23, and the liquid sealing groove 23 is defined in a surface 21 and located adjacent the helical water groove 22. A through hole 25 is formed in the center of the stator base 20, and a plurality of threaded holes 27 is defined in the end surface 26 between the through hole 25 and the outer surface 21 of the annular stator base 20.

The silicon steel sheets 30 are mounted on the inner surface of the through hole 25 in the stator base 20.

The coils 40 are wound around the silicon steel sheets 30 in the stator base 20.

The sealing glue 50 is injected into the inner surface of the through hole 25 of the stator base 20 to cover and position the abovementioned coils 40 and the silicon steel sheets 30 after solidification.

The water cooed sealing tube 60 is a hollow tube with a thin wall, and the hollow through hole 61 of the water cooled sealing tube 60 serves to accommodate the stator base 20 in such a manner that the surface 21 of the stator base 20 abuts against the inner surface of the hollow through hole 61 of the water cooled sealing tube 60. Two water circulating holes 62 are defined in the surface of the water cooled sealing tube 60 and located correspondingly to both ends of the helical water groove 22 of the stator base 20. The water cooled sealing tube 60 is mounted outside the stator base 20 to seal the helical water groove 22 of the stator base 20 by liquid. A plurality of threaded holes 63 is defined in the end surface 64 of the water cooled sealing tube 60 and located correspondingly to the threaded holes 27 of the stator 20.

The cover board 70 is formed in the shape of an annular sheet and is disposed on the end surface 26 of the stator 20 and the end surface 64 of the water cooled sealing tube 60. In the sealing cover board 70 are formed a plurality of holes 71 located correspondingly to the threaded holes 63 of the water cooled sealing tube 60 and the threaded holes 27 of the stator base 20, whereby the water cooled sealing tube 60 and the stator base 20 are fixed to each other by screws 72.

The abovementioned is the summary of the positional and structural relationship of the respective components of the preferred embodiment in accordance with the present invention.

For a better understanding of the present invention, its operation and function, reference should be made to the descriptions as follows:

Sealing glue 50 is injected into the inner surface of the through hole 25 in the stator 20 to cover and position the abovementioned coils 40 and silicon steel sheets 30 after solidification. Therefore, the components in the stator base 20 can be fixed steadily.

It is to be noted that the water cooled sealing tube 60 is a hollow tube with a thin wall and without any protruding structures, so the volume of the products can be effectively reduced. Additionally, the tube shaped design of the water cooled sealing tube 60 makes it easier for the tube 60 to be applied to various tool machines, and the water cooled sealing tube 60 can be disposed at different positions in various tool machines.

Moreover, the sealing tube 60 can be mass produced rapidly by utilizing the tube-making technology. The tube shaped water cooled sealing tube 60 consumes less material than the conventional aluminum base. Nowadays, the tube-making technology is simple and has a low cost. The manufacturer of the present invention does not need to make complex processes, and the time and cost of producing the water cooled sealing tube 60 can be effectively reduced. Therefore, the present invention can utilize the water cooled sealing tube 60 which is a hollow tube with a thin wall to reduce the cost.

When the water cooled sealing tube 60 cooperates with the cover board 70 to seal the stator 20, in the sealing cover board 70 are formed a plurality of holes 71 located correspondingly to the threaded holes 63 of the water cooled sealing tube 60 and the threaded holes 27 of the stator base 20, whereby the water cooled sealing tube 60 and the stator base 20 are fixed to each other by screws 72. Therefore, the present invention simplifies the fixing of the liquid sealing structure of the water cooled sealing tube 60. Although the water cooled sealing tube 60 is a hollow tube with a thin wall, it will not be hard to be fixed.

The present invention further has the following characteristics:

Firstly, the water cooled sealing tube 60 which is a hollow tube with a thin wall not only can reduce the volume and weight, but also can extend the application and installation scope of the products.

Secondly, the water cooled sealing tube 60 can be produced by tube-making technology which is simple and has a low cost.

Thirdly, the abovementioned tube shaped design of the water cooled sealing tube 60 can be applied to various tool machines, and the water cooled sealing tube 60 can be disposed at different positions in various tool machines.

To summarize, the main components of the present invention comprises a stator, silicon steel sheets, coils, sealing glue and a water cooled sealing tube. A helical water groove is defined in the outer surface of the stator base. The silicon steel sheets and coils are fixed in the stator base by the sealing glue after solidification. Then, the water cooled sealing tube is directly mounted outside the stator to seal the helical water groove of the stator base by liquid. By such arrangement, the water cooled sealing tube is used to accomplish simple and independent water cooled sealing, and the volume of the products can be effectively reduced, so it can be applied to various tool machines.

While we have shown and described various embodiments in accordance with the present invention, it is clear to those skilled in the art that further embodiments may be made without departing from the scope of the present invention.

What is claimed is:

1. A water cooled stator for a direct drive torque motor, comprising:
an annular stator base with a helical water groove defined in an outer surface thereof and with a through hole formed in a center thereof;
a plurality of silicon steel sheets disposed in the through hole;
a plurality of coils wound around the silicon steel sheets in the stator base;
sealing glue being injected into the through hole of the stator base to cover the coils and the silicon steel sheets after solidification; and
a hollow sealing tube, the hollow through hole of the water cooled sealing tube serving to accommodate the stator base in such a manner that a surface of the stator base abuts against an inner surface of the hollow through hole of the water cooled sealing tube, a plurality of water circulating holes defined in a surface of the water cooled sealing tube and located correspondingly to the helical water groove of the stator base, and the water cooled sealing tube mounted outside the stator base to seal the helical water groove of the stator base by liquid.

2. The water cooled stator for a direct drive torque motor as claimed in claim 1, wherein an 0-shaped ring is mounted in a liquid sealing groove and the liquid sealing groove is defined in a surface and located adjacent the helical water groove.

3. The water cooled stator for a direct drive torque motor as claimed in claim 1, wherein:
a plurality of threaded holes is defined in an end surface between the through hole and the outer surface of the stator base;
a plurality of threaded holes is defined at an end surface of the water cooled sealing tube and located correspondingly to the threaded holes of the stator base; and
a water cooled cover board which is formed in the shape of an annular sheet and is disposed on the end surface of the annular stator base and the end surface of the water cooled sealing tube, in the sealing cover board are formed a plurality of holes located correspondingly to the threaded holes of the water cooled sealing tube and the threaded holes of the stator base, whereby the water cooled sealing tube and the stator base are fixed to each other by screws.

4. The water cooled stator for the a direct drive torque motor as claimed in claim 1, wherein the helical water groove is defined in the outer surface of the stator base, and the water cooled sealing tube serves to seal the helical water groove of the stator base by liquid.

5. The water cooled stator for the a direct drive torque motor as claimed in claim 3, wherein the helical water groove is defined in the outer surface of the stator base, and the water cooled sealing tube serves to seal the helical water groove of the stator base by liquid.
